(19) United States
(12) Patent Application Publication
(10) Pub. No.: US 2015/0193789 A1
(43) Pub. Date: Jul. 9, 2015

(54) METHOD AND SYSTEM FOR PERSONALIZED NEWS RECOMMENDATIONS BASED ON PURCHASE BEHAVIOR

(71) Applicant: MasterCard International Incorporated, Purchase, NY (US)

(72) Inventors: Jean-Pierre GERARD, Croton-On-Hudson, NY (US); Po HU, Norwalk, CT (US)

(73) Assignee: MasterCard International Incorporated, Purchase, NY (US)

(21) Appl. No.: 14/147,139

(22) Filed: Jan. 3, 2014

(51) Int. Cl. G06Q 30/02; H04L 29/08

(52) U.S. Cl. CPC G06Q 30/0202; H04L 67/1095

(57) ABSTRACT

A method for identifying news interest levels includes: storing a plurality of transaction data entries, each transaction data entry including data related to a payment transaction involving a consumer of a plurality of consumers including transaction data and a consumer identifier associated with the involved consumer; storing a plurality of interest scoring rules, each interest scoring rule associated with at least one news category; identifying a subset of transaction data entries where each entry in the subset includes a common consumer identifier associated with a specific consumer; identifying a plurality of news interest levels based on an application of the plurality of interest scoring rules to the transaction data included in the transaction data entries of the subset of transaction data entries; and transmitting the identified plurality of news interest levels for use in identifying news-related content for distribution to a consumer associated with the common consumer identifier.

### FIELD

The present disclosure relates to the identification of news interest levels and distribution of news-related content based thereon, specifically the use of transaction data and purchase behaviors to identify news interest levels for a consumer for use in providing news-related content to the consumer.

### BACKGROUND

Traditionally, consumers received news from either newspapers and other periodicals or word of mouth. The advent of radio and television provided new ways for consumers to receive the news and news related content with methods that could reach consumers in new places, faster, and reach a wide variety of consumers at once. In many instances, consumers could freely choose among the various methods and various news providers, in an effort to receive news that the consumer had a greater interest in. However, the ability for consumers to customize their news could still be hampered by selections of news by the news providers, as well as the news providers targeting a wide audience as opposed to the interests of specific consumers.

The advent of the Internet enabled consumers to start receiving news tailored to their specific needs. In some instances, news providers operate websites where consumers may take a survey to identify interests or otherwise submit preferences as to news interests. The website may then select news articles and other news related content for delivery to the consumer based on the consumer provided interests. As a result, the consumer may receive news more specifically aligned to their interests.

However, such methods often require significant participation by the consumer to be effective. In addition to requiring consumer participation in identifying consumer news interest levels, such methods often do not accommodate changing interests of behaviors of the consumer, without the consumer first notifying the news provider of such changed interest. Furthermore, in many instances a consumer may not be actively aware of an interest or potential interest, and thus may not communicate the interest to the news provider and therefore not avail themselves of content related to that interest.

Also, browsing history can be used to effectively filter news stories being presented to an Internet user, but the browsing history may not be isolated to a particular user of a shared computer, and does not always accurately reflect the full range of interested of the user.

Thus, the present inventors believe there is a need for a technical solution to identify news interest levels for a consumer without requiring consumer participation and to provide news related content to the consumer based on the interest levels.

### SUMMARY

The present disclosure provides a description of systems and methods for identifying news interest levels and distributing news-related content.

A method for identifying news interest levels includes: storing, in a transaction database, a plurality of transaction data entries, wherein each transaction data entry includes data related to a payment transaction involving a consumer of a plurality of consumers including at least transaction data and a consumer identifier associated with the involved consumer; storing, in a rules database, a plurality of interest scoring rules, wherein each interest scoring rule is associated with at least one news category; identifying, in the transaction database, a subset of transaction data entries where each transaction data entry in the subset includes a common consumer identifier associated with a specific consumer of the plurality of consumers; identifying, by a processing device, a plurality of news interest levels based on at least an application of the plurality of interest scoring rules to the transaction data included in the transaction data entries of the subset of transaction data entries; and transmitting, by a transmitting device, the identified plurality of news interest levels for use in identifying news-related content for distribution to a consumer associated with the common consumer identifier.

A method for distributing news-related content includes: storing, in a consumer database, a consumer profile, wherein the consumer profile includes data related to a consumer including at least a plurality of transaction data entries, each transaction data entry being related to a payment transaction involving the consumer and including at least transaction data; storing, in a content database, a plurality of content profiles, wherein each content profile includes data related to a news-related content item including at least one piece of content and at least one associated news category; identifying, by a processing device, a plurality of news interest levels for the consumer based on at least one interest scoring rule and the transaction data included in the plurality of transaction data entries of the consumer profile, wherein each news interest level is associated with at least one news category; identifying, in the content database, a specific content profile based on at least the included at least one associated news category and the identified plurality of news interest levels; and transmitting, by a transmitting device, the at least one piece of content included in the identified specific content profile to the consumer.

A system for identifying news interest levels includes a transaction database, a rules database, a processing device, and a transmitting device. The transaction database is configured to store a plurality of transaction data entries, wherein each transaction data entry includes data related to a payment transaction involving a consumer of a plurality of consumers including at least transaction data and a consumer identifier associated with the involved consumer. The rules database is configured to store a plurality of interest scoring rules, wherein each interest scoring rule is associated with at least one news category. The processing device is configured to: identify, in the transaction database, a subset of transaction data entries where each transaction data entry in the subset includes a common consumer identifier associated with a specific consumer of the plurality of consumers; and identify a plurality of news interest levels based on at least an application of the plurality of interest scoring rules to the transaction data included in the transaction data entries of the subset of transaction data entries. The transmitting device is configured to transmit the identified plurality of news interest levels for use in identifying news-related content for distribution to a consumer associated with the common consumer identifier.

A system for distributing news-related content includes a consumer database, a content database, a processing device, and a transmitting device. The consumer database is configured to store a consumer profile, wherein the consumer profile includes data related to a consumer including at least a plurality of transaction data entries, each transaction data entry being related to a payment transaction involving the consumer and including at least transaction data. The content database is configured to store a plurality of content profiles, wherein each content profile includes data related to a news-related content item including at least one piece of content and at least one associated news category. The processing device is configured to: identify a plurality of news interest levels for the consumer based on at least one interest scoring rule and the transaction data included in the plurality of transaction data entries of the consumer profile, wherein each news interest level is associated with at least one news category; and identify, in the content database, a specific content profile based on at least the included at least one associated news category and the identified plurality of news interest levels. The transmitting device is configured to transmit the at least one piece of content included in the identified specific content profile to the consumer.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for identifying personalized news interest levels and news related content in accordance with exemplary embodiments.

FIG. 2 is a block diagram illustrating the processing server of FIG. 1 for the identification of news interest levels and distribution of personalized news related content in accordance with exemplary embodiments.

FIG. 3 is a flow diagram illustrating a process for identifying news interest levels for use in distributing news related content using the system of FIG. 1 in accordance with exemplary embodiments.

FIG. 4 is a flow diagram illustrating a process for identifying news interest levels and distributing news related content using the processing server of the system of FIG. 1 in accordance with exemplary embodiments.

FIG. 5 is a diagram illustrating the selection of news related content for distribution to a consumer based on identified personalized news interest levels in accordance with exemplary embodiments.

FIG. 6 is a flow chart illustrating an exemplary method for identifying news interest levels in accordance with exemplary embodiments.

FIG. 7 is a flow chart illustrating an exemplary method for distributing news related content in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc.

### System for Identifying Consumer News Interest Levels

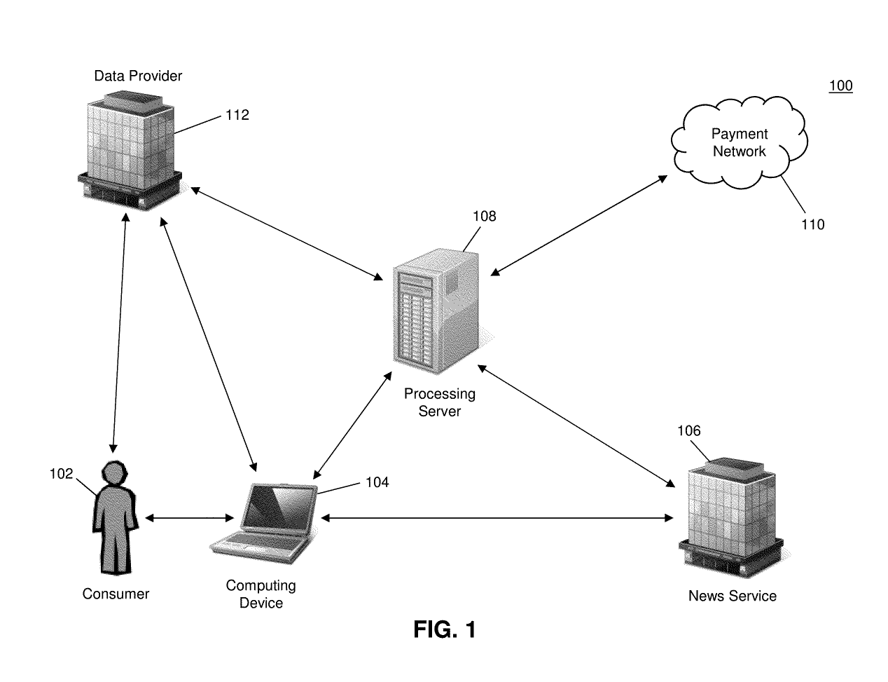

FIG. 1 illustrates a system 100 for identifying news interest levels for a consumer based on transaction data and purchase behaviors and use thereof for identifying news related content for distribution. This information may be used alone, or in conjunction with conventional ways to determine interests, e.g., from browsing history or surveys.

The system 100 may include a consumer 102. The consumer 102 may use a computing device 104 to regularly access news and news related content, such as via the Internet, an application program, or other suitable method. The computing device 104 may be any type of computing device suitable for performing the functions as discussed herein, such as a desktop computer, laptop computer, notebook computer, tablet computer, cellular phone, smart phone, etc. The computing device 104 may receive news and news related content from a news service 106.

The system 100 may also include a processing server 108. The processing server 108, discussed in more detail below, may be configured to identify news interest levels for the consumer 102 for use by the news service 106 and/or the processing server 108 in identifying news related content tailored to the consumer 102 for distribution to the consumer 102. The processing server 108 may identify news interest levels based on transaction data for payment transactions involving the consumer 102. The processing server 108 may receive the transaction data from a payment network 110. The transaction data may include a transaction amount, transaction time and/or date, product data, merchant data, geographic location, or other suitable data for each payment transaction.

For example, the processing server 108 may identify that the consumer 102 is interested in sports based on conducting payment transactions with sporting goods merchants or transactions for attending sporting events. In some instances, the processing server 108 may identify specific sports or sports teams that the consumer 102 may be particularly interested in. The processing server 108 may then transmit the news interest levels for the consumer 102, such as interest in a specific sports team, to the news service 106. The news service 106 may then identify news related content based on the news interest levels, and provide the content to the consumer 102. For example, the news service 106 may identify any news articles related to the specific sports team and distribute those articles to the consumer 102.

In some embodiments, the news service 106 may identify a plurality of news related content items of varying categories based on interest levels of the consumer 102. For example, the news service 106 may identify news articles from ten different news categories based on news interest levels of the consumer 102, and may weigh presentation of each of the articles to the consumer, or repetition of articles from a category, based on consumer interest levels in each respective category. For instance, a consumer 102 heavily interested in the Washington Redskins, who is also interested in football generally, and is also somewhat interested in technology and smartphones may receive news articles related to each interest, with more articles related to football being presented than articles about smartphones, and with many or even every article associated with the Redskins being presented. Methods and systems for selecting news articles and news related content based on interest levels will be apparent to persons having skill in the relevant art.

In one embodiment, the processing server 108 may be configured to transmit news related content to the computing device 104 based on news interest levels for the consumer 102. In such an embodiment, the processing server 108 may receive news related content from the news service 106. Each news related content item may be associated with one or more news categories (e.g., which may be, or may be associated with, one or more news interests). The processing server 108 may then identify news related content for the consumer 102 based on their news interest levels, and distribute the content to the computing device 104 using methods and systems that will be apparent to persons having skill in the relevant art.

In some instances, the processing server 108 may use additional data for identifying news interest levels for the consumer 102 in addition to transaction data. In one embodiment, the processing server 108 may receive demographic characteristic data from a data provider 112 corresponding to demographics associated with the consumer 102, such as age, gender, familial status, marital status, residential status, income, education, occupation, zip code, postal code, etc. In some instances, the demographic characteristic data may not include any personally identifiable information, or may be obtained with consent of the consumer 102. For example, the consumer 102 may provide consent to the data provider 112 to provide demographic data to other parties when providing demographic data to the data provider 112. In another example, the data provider 112 may anonymize the demographics data provided to the processing server 108, such as by bucketing the data, or withholding data that may result in the demographics being personally identifiable to the consumer 102. The processing server 108 may also utilize consumer feedback or consumer preferences supplied by the consumer 102, advertising data associated with the consumer 102, or other data that may also be suitable for identifying consumer news interest levels as will be apparent to persons having skill in the relevant art.

By identifying news interest levels based on transaction data, the processing server 108 may be configured to identify news interest levels for a consumer 102 that are more accurate as to the consumer's interests than relying solely on consumer-submitted information. In addition, the processing server 108 may continuously receive transaction data from the payment network 110, which may enable the processing server 108 to continuously update a consumer's news interest levels, and thus provide for real-time updating of interests and for the identifying of changing interests over time, without requiring continual providing of data by the consumer 102. Furthermore, such a process may require minimal participation by the consumer 102, yet still result in the receipt of news related content identified specifically tailored to the consumer 102.

### Processing Server

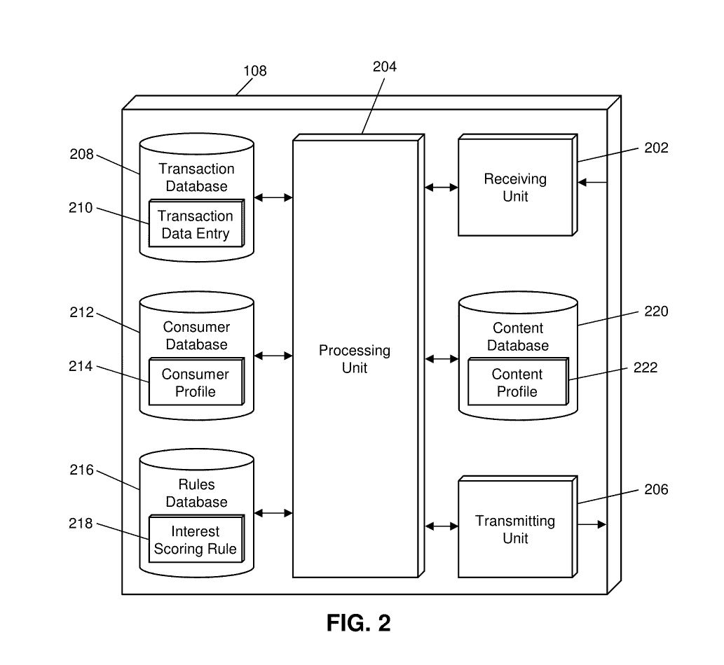

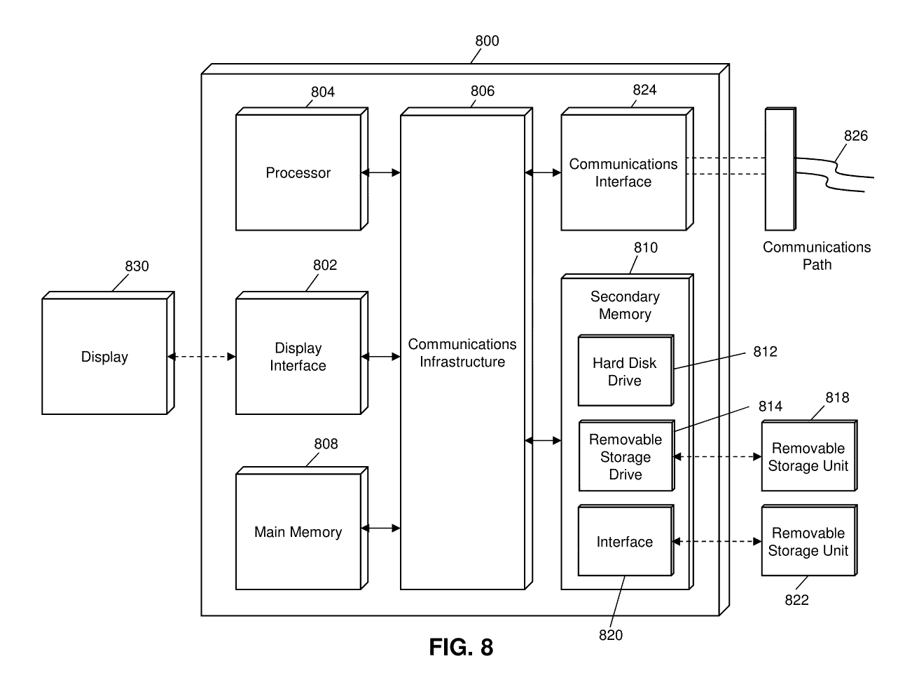

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 800 illustrated in FIG. 8 and discussed in more detail below may be a suitable configuration of the processing server 108.

The processing server 108 may include a receiving unit 202. The receiving unit 202 may be configured to receive data over one or more networks via one or more network protocols. The receiving unit 202 may receive transaction data from the payment network 110 for a plurality of payment transactions. The processing server 108 may also include a processing unit 204. The processing unit 204 may be configured to store the received transaction data in a transaction database 208 as a plurality of transaction data entries 210.

Each transaction data entry 210 may include data related to a payment transaction involving a consumer (e.g., the consumer 102) including at least transaction data and a consumer identifier associated with the involved consumer 102. The transaction data included therein may include a transaction amount, transaction time and/or data, merchant data product data, etc. The consumer identifier may be a unique value associated with the consumer 102 involved in the payment transaction suitable for identification of the consumer 102, such as a payment account number, telephone number, e-mail address, username, identification number, etc. In some instances, the consumer identifier may be a device identifier associated with a computing device 104 associated with the consumer 102, such as a media access control address, Internet protocol address, etc.

The processing server 108 may also include a consumer database 212. The consumer database 212 may include a plurality of consumer profiles 214. Each consumer profile 214 may include data related to a consumer 102 including at least the consumer identifier associated with the related consumer 102. The consumer profile 214 may further include demographic data or other data associated with the consumer 102 (e.g., and received by the receiving unit 202 from the data provider 112). The consumer profile 214 may also include news interest levels for the related consumer 102 as identified by the processing unit 204 and discussed in more detail below. Alternatively or additionally, the transaction data entries 210 can be captured by a transaction enabled computer 104 or computers, such as a smartphone with Near Field Communication (NFC) capabilities, and the consumer profile 214 supplemented with browser history from the browser on the computer device. Another alternative is that browser and other sources of data that indicated interests of the consumer 102 can supplement the consumer profile 214.

The receiving unit 202 may be configured to receive a request for news interest levels from the news service 106. The request may include at least a consumer identifier associated with a consumer 102 for whom news interest levels are requested. The processing unit 204 may identify transaction data entries 210 included in the transaction database 208 that include the consumer identifier included in the received request. The processing unit 204 may then identify news interest levels for the consumer 102 based on the transaction data included in each of the identified transaction data entries 210.

In some embodiments, the news interest levels may be identified by the processing unit 204 using one or more interest scoring rules 218. The interest scoring rules 218 may be stored in a rules database 216 of the processing server 108 and may be applied to transaction data for payment transactions to identify news interest levels for a consumer 102. The processing unit 204 may apply the interest scoring rules 218 to the transaction data in the identified transaction data entries 210 to obtain the news interest levels for the consumer 102. In one embodiment, the processing unit 204 may update a consumer profile 214 associated with the consumer 102, based on the consumer identifier, to include the identified news interest levels.

In such an embodiment, the processing server may be configured to supply news interest levels to the news service 106 immediately if levels were previously identified for a consumer 102 without the need to re-identify the consumer's news interest levels. In some instances, the processing unit 204 may be configured to identify new news interest levels for the consumer 102 at predetermined periods of time. For example, the processing unit 204 may refresh the news interest levels for a consumer 102 if at least a week has elapsed since the previous update, if new transactions involving the consumer 102 have been received, if requested by the consumer 102, if requested by the news service 106, etc.

In some embodiments, the processing unit 204 may be configured to identify news interest levels based on purchase models and transaction behavior. In such an embodiment, the processing unit 204 may identify transaction behavior for the consumer 102 based on at least the transaction data included in the identified transaction data entries 210 of the transaction database 208 that correspond to payment transactions involving the consumer 102. The processing unit 204 may then identify one of a plurality of purchase models based on the transaction behavior for the consumer 102 and one or more of the interest scoring rules 218. The identified news interest levels for the consumer 102 may then be based on the purchase model identified for the consumer 102.

The processing server 108 may further include a transmitting unit 206. The transmitting unit 206 may be configured to transmit data over one or more networks via one or more network protocols. The transmitting unit 206 may transmit the identified news interest levels to the news service 106 in response to the received request.

In some embodiments, the processing server 108 may be configured to provide news related content directly to the consumer 102. In such an embodiment, the consumer 102 may request news related content via the computing device 104. The receiving unit 202 may receive a request for news related content from the computing device 104, wherein the request includes at least the consumer identifier associated with the consumer 102. The processing unit 204 may identify a consumer profile 214 associated with the consumer 102 and identify the news interest levels for the consumer 102, as discussed above.

In such an embodiment, the receiving unit 202 may receive news related content from one or more third parties, such as the news service 106. The processing unit 204 may store the received news related content (either the content in its entirety or some portion thereof (title, teaser or abstract, for example), or a link to the original source, etc.) in one or more related content profiles 222 stored in a content database 220 included in the processing server 108. Each content profile 222 may include data related to a news related content item including at least one piece of content and at least one associated news category. The at least one piece of content may include a news article, news release, press release, news report, product offering, product advertisement, product offer, blog article, or other suitable news related content item as will be apparent to persons having skill in the relevant art. The associated news category or categories may include one of a plurality of suitable news categories associated with the content item(s). In some instances, the news categories may directly correspond to news interest levels that are identified for consumers.

The processing unit 204 may identify a specific content profile 222 in the content database 220 for the consumer 102 based on the at least one associated news category included in the specific content profile 222 and the news interest levels included in the consumer profile 214 associated with the consumer 102. The processing unit 204 may use one or more algorithms or rules to identify a content profile 222 based on news interest levels of the consumer 102. For example, some interest levels or news categories may be weighted more heavily than others, some content profiles 222 may have priority over others (e.g., for breaking news stories, important news stories, emergency alerts, etc.), and other rules that will be apparent to persons having skill in the relevant art. Once a specific content profile 222 is identified, the transmitting unit 206 may transmit the at least one piece of content included in the specific content profile 222 to the computing device 104.

In some embodiments, the consumer profile 214 may further include feedback data. The feedback data may correspond to feedback received from the associated consumer 102 regarding news related content distributed to the consumer 102. For example, after news related content is distributed to the consumer 102, the receiving unit 202 may receive feedback from the consumer 102 (e.g., via the computing device 104) regarding the distributed content, such as an indication that similar content is desired. The processing unit 204 may then update the feedback data in the consumer profile 214 accordingly. In some instances, the processing unit 204 may directly update the news interest levels for the consumer 102 based on the feedback.

### Process for Identifying News Interest Levels

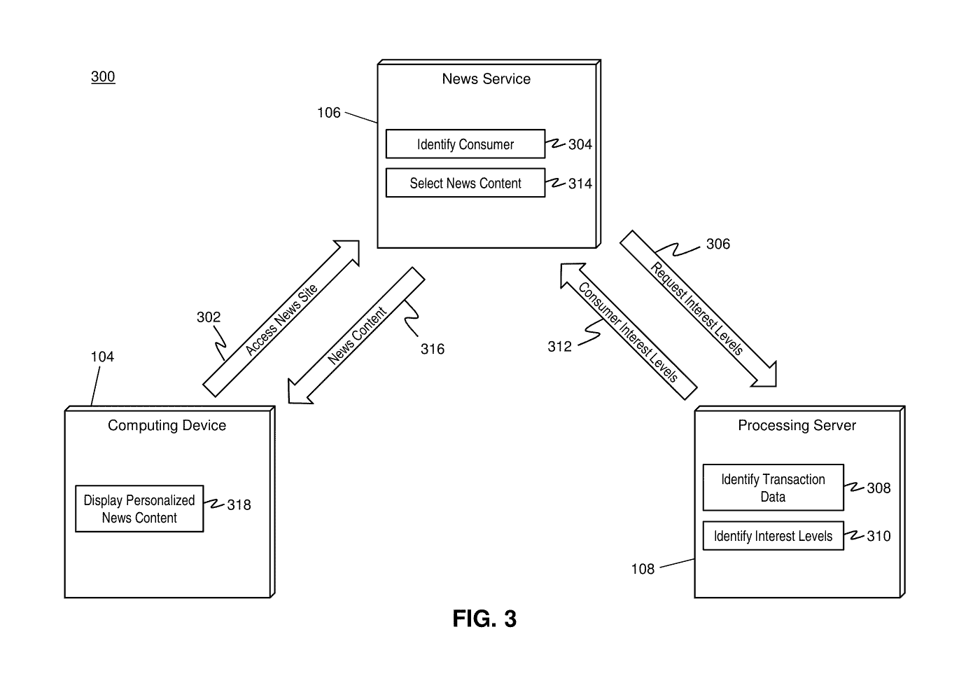

FIG. 3 illustrates a process 300 for identifying news interest levels using the system 100 of FIG. 1 for a consumer 102 for providing to a news service 106 for use in identifying news related content for distribution to the consumer 102.

In step 302, the computing device 104 may access a news website operated by or on behalf of the news service 106. In some embodiments, the computing device 104 may request news content from the news service 106 via an application program or other suitable program rather than a news website. In step 304, the news service 106 may identify the consumer 102 associated with the computing device 104 using methods and systems that will be apparent to persons having skill in the relevant art. For example, the news service 106 may utilize cookies, login information of the consumer 102, or other suitable method to identify the consumer 102. Identification of the consumer 102 may include at least identifying the consumer identifier associated with the consumer 102.

In step 306, the news service 106 may transmit the consumer identifier associated with the consumer 102 to the processing server 108 in a request for news interest levels. The receiving unit 202 of the processing server 108 may receive the request, and, in step 308, may identify transaction data entries 210 stored in the transaction database 208 related to payment transactions involving the consumer 102 using the consumer identifier. In step 310, the processing unit 204 of the processing server 108 may identify news interest levels for the consumer 102 based on the transaction data included in each of the identified transaction data entries 210. In embodiments where news interest levels for the consumer 102 were previously identified, step 308 may be an optional step and step 310 may include identifying the previously identified news interest levels for the consumer 102, such as stored in a consumer profile 214 of the consumer database 212 associated with the consumer 102.

In step 312, the transmitting unit 206 of the processing server 108 may transmit the identified news interest levels for the consumer 102 to the news service 106. In step 314, the news service 106 may select news content based on the news interest levels of the consumer 102 using methods and systems that will be apparent to persons having skill in the relevant art. In step 316, the news service 106 may transmit the news content to the computing device 104, such as via the accessed news site or application program. In step 318, the computing device 104 may then display the personalized news content to the consumer 102.

### Process for Identifying News Related Content

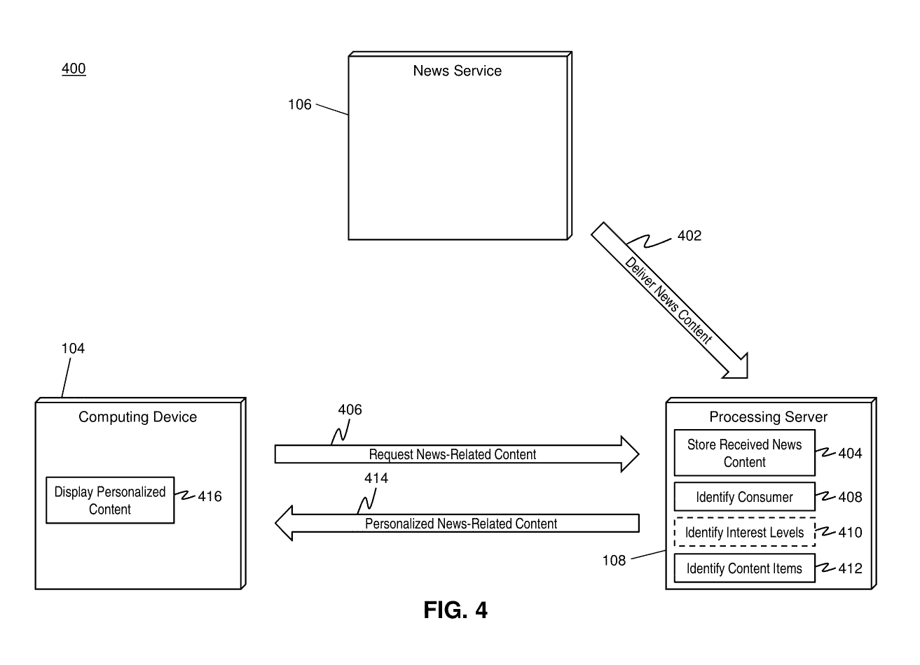

FIG. 4 illustrates a method 400 for identifying news related content for distribution to a consumer 102 based on news interest levels of the consumer 102 using the system 100 of FIG. 1.

In step 402, the news service 106 and/or other entities having news related content may deliver the news related content to the processing server 108. The receiving unit 202 of the processing server 108 may receive the news related content, and, in step 404, the processing unit 204 of the processing server 108 may store the news related content in one or more content profiles 222 in the content database 220. Each content profile 222 may include one or more content items and at least one associated news category.

In step 406, the computing device 104 may submit a request for news related content to the processing server 108. The request may include at least a consumer identifier associated with the consumer 102 operating and/or associated with the computing device 104. In step 408, the processing unit 204 may identify the consumer 102. Identification of the consumer 102 may include identifying the consumer identifier included in the request, identifying the consumer identifier associated with the consumer 102 based on the request (e.g., by identifying the computing device 104 and the consumer identifier associated with the computing device 104, by using cookies stored on the computing device 104, etc.), or identifying a consumer profile 214 stored in the consumer database 212 including the consumer identifier included in the request.

In step 410, the processing unit 204 may identify news interest levels for the consumer 102. The news interest levels may be identified based on transaction data associated with the consumer and included in transaction data entries 210 stored in the transaction database 208. In some embodiments, step 410 may be an optional step. In such an embodiment, the processing unit 204 may have previously identified news interest levels associated with the consumer 102, which may be included in the consumer profile 214 associated with the consumer 102 and identified by the processing unit 204 in step 408.

In step 412, the processing unit 204 may identify a content profile 222 stored in the content database 220 based on at least the included one or more associated news categories and the interest levels associated with the consumer 102. In step 414, the transmitting unit 206 of the processing server 108 may transmit the at least one content item included in the identified content profile 222 to the computing device 104. The computing device 104 may then, in step 416, display the personalized content to the consumer 102.

### Identification of Personalized News Related Content

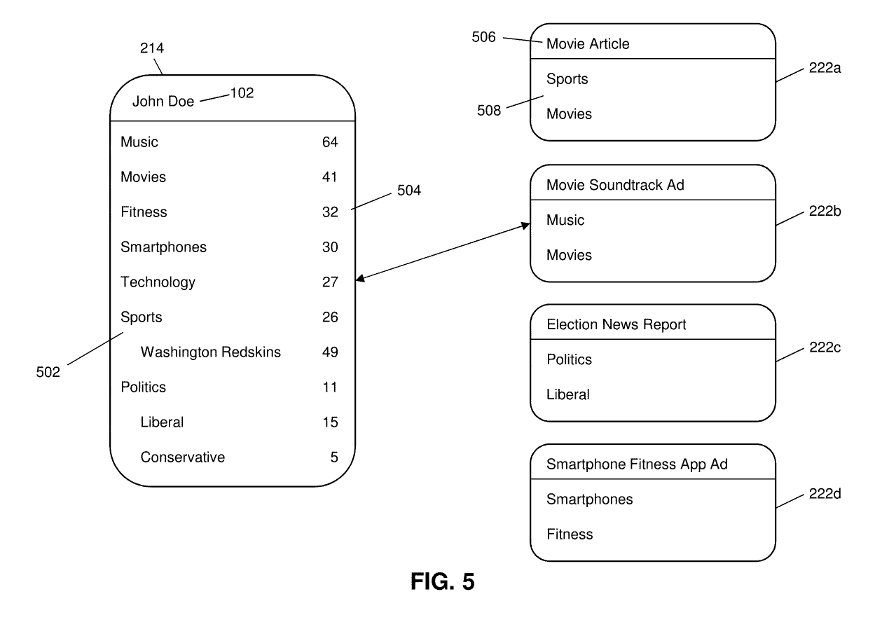

FIG. 5 is a diagram illustrating the identification of news related content personalized for the consumer 102 based on news interest levels using the methods and systems discussed herein. It will be apparent to persons having skill in the relevant art that the example illustrated in FIG. 5 is provided as means of illustration only and may not be exhaustive as to the selection of a news related content item based on news interest levels using the methods and systems discussed herein.

As illustrated in FIG. 5, a consumer profile 214 associated with a consumer 102, John Doe, may include a plurality of news categories 502. In some instances, the news categories for a consumer 102 may include a news category 502 that may be a subset of a broader news category 502. For example, in the example illustrated in FIG. 5, John Doe's consumer profile 214 may include a news category 502 for sports news, and an additional news category 502 for news regarding Washington Redskins. Such narrower news categories may provide for the identification of more personalized news content. For example, a consumer 102 may not desire to see news regarding a sport generally, but may be interest in news about a specific division or conference, or a specific team.

Each news category 502 may have a corresponding news interest level 504. Although the news interest levels 504 are illustrated as number values, additional values may be used for the news interest levels 504 as will be apparent to persons having skill in the relevant art. For instance, news interest levels 504 may be represented by colors (e.g., red for high interest, blue for low interest), words (e.g., “very high” interest, “high” interest, “low” interest, etc.), and other suitable values.

FIG. 5 also illustrates a plurality of content profiles 222, illustrated as content profiles 222a, 222b, 222c, and 222d. Each content profile 222 may include at least one content item 506 and one or more associated news categories 508. In the example illustrated in FIG. 5, each content profile 222 includes two associated news categories 508. The processing unit 204 of the processing server 108 may identify a content profile 222 for distribution of the included content item 506 based on the included associated news categories 508 and the news interest levels 504 in the consumer profile 214.

In the example illustrated in FIG. 5, the processing unit 204 may identify content profile 222b, which corresponds to an advertisement for a movie soundtrack, for distribution to the consumer 102. In the example, the two associated news categories 508 for the movie soundtrack advertisement, music and movies, have the two highest news interest levels 504 for the consumer 102. As the combined news interest levels 504 for the two associated news categories 508 are the highest for the content profile 222b, the processing unit 204 may identify the content profile 222b for distribution, and instruct the transmitting unit 206 of the processing server 108 to transmit the content item 506, the movie soundtrack advertisement, to the computing device 104 for display to the consumer 102.

### Exemplary Method for Identifying News Interest Levels

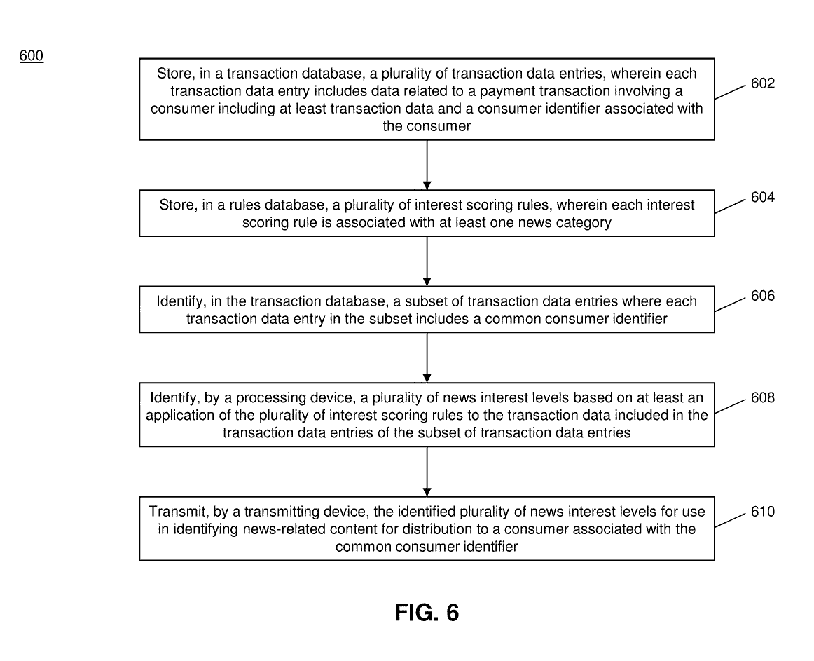

FIG. 6 illustrates a method 600 for the identification of news interest levels for a consumer based on transaction data.

In step 602, a plurality of transaction data entries (e.g., transaction data entries 210) may be stored in a transaction database (e.g., the transaction database 208), wherein each transaction data entry 210 includes data related to a payment transaction involving a consumer (e.g., the consumer 102) including at least transaction data and a consumer identifier associated with the consumer 102. In one embodiment, the transaction data includes at least one of: a transaction amount, a transaction time and/or date, product data, merchant data, and geographic location. In some embodiments, the consumer identifier may be a payment account identifier corresponds to a payment account associated with the associated consumer 102.

In step 604, a plurality of interest scoring rules (e.g., interest scoring rules 218) may be stored in a rules database (e.g., the rules database 216), wherein each interest scoring rule 218 is associated with at least one news category. In one embodiment, the at least one news category includes at least one of: business, politics, finance, sports, health, fitness, entertainment, technology, and travel. In step 606, a subset of transaction data entries 210 may be identified, in the transaction database 208, where each transaction data entry 210 in the subset includes a common consumer identifier.

In step 608, a plurality of news interest levels may be identified, by a processing device (e.g., the processing unit 204), based on at least an application of the plurality of interest scoring rules 218 to the transaction data included in the transaction data entries 210 of the subset of transaction data entries 210. In one embodiment, the identified plurality of news interest levels may be further based on at least one of: browsing data, consumer feedback, consumer preferences, demographic data, advertising data, and consumer response data. In another embodiment, application of the plurality of interest scoring rules 218 may further include: identifying, by the processing device 204, transaction behavior for the specific consumer 102 based on at least the transaction data included in the transaction data entries 210 of the subset of transaction data entries 210; and identifying, by the processing device 204, an associated purchase model of a plurality of consumer purchase models based on the identified transaction behavior for the specific consumer 102 and the plurality of interest scoring rules 218. In a further embodiment, the plurality of news interest levels are based on the identified associated purchase model.

In step 610, the identified plurality of news interest levels may be transmitted, by a transmitting device (e.g., the transmitting unit 206), for use in identifying news-related content for distribution to a consumer 102 associated with the common consumer identifier. In one embodiment, the method 600 may further include receiving, by a receiving device (e.g., the receiving unit 202), a request for news interest levels, wherein the request includes the common consumer identifier. In a further embodiment, the identified plurality of news interest levels may be transmitted in response to the received request for news interest levels.

### Method for Distributing News-Related Content

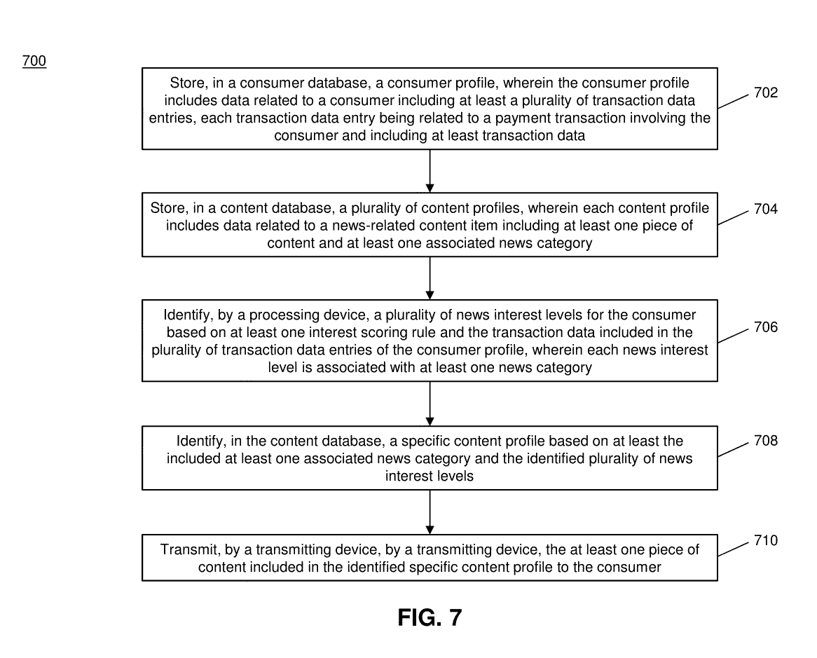

FIG. 7 illustrates a method 700 for distributing news-related content to a consumer based on news interest levels based on transaction data.

In step 702, a consumer profile (e.g., the consumer profile 214 for each of a plurality of consumers 102) may be stored in a consumer database (e.g., the consumer database 212), wherein the consumer profile 214 includes data related to a consumer (e.g., the consumer 102) including at least a plurality of transaction data entries (e.g., transaction data entries 210), each transaction data entry being related to a payment transaction involving the consumer 102 and including at least transaction data. In one embodiment, the transaction data may include at least one of: a transaction amount, a transaction time and/or date, product data, merchant data, and geographic location. Demographics, data tending to indicate areas of interest and other data captured through conventional means (e.g., browser history, surveys, third party aggregators and profile developers, etc.) may be part of the consumer profile 214, depending on implementation.

In step 704, a plurality of content profiles (e.g., content profiles 222) may be stored in a content database (e.g., the content database 220), wherein each content profile 222 includes data related to a news-related content item including at least one piece of content and at least one associated news category. In one embodiment, the at least one associated news category and the at least one news category may be at least one of: business, politics, finance, sports, health, fitness, entertainment, technology, and travel. In some embodiments, the news-related content item may include at least one of: news article, press release, news report, product offering, product advertisement, product offer, and blog article. In one embodiment, the at least one piece of content may be at least one of: a data file, a hyperlink, and a uniform resource locator.

In step 706, a plurality of news interest levels may be identified, by a processing device (e.g., the processing unit 204), for the consumer 102 based on at least one interest scoring rule (e.g., interest scoring rule 218) and the transaction data included in the plurality of transaction data entries 210 of the consumer profile 214, wherein each news interest level is associated with at least one news category. In some embodiments, the plurality of news interest levels may be further based on a purchase model associated with the consumer 102 identified via an application of the at least one interest scoring rule 218 to the transaction data included in the plurality of transaction data entries 210 of the consumer profile 214. In one embodiment, the consumer profile 214 may further include browsing data associated with the consumer 102, and the identified plurality of news interest levels may be further based on the browsing data included in the consumer profile 214 and associated with the consumer 102.

In another embodiment, the consumer profile 214 may further includes consumer data associated with the consumer 102, and the identified plurality of news interest levels may be further based on the consumer data included in the consumer profile 214 and associated with the consumer 102. In a further embodiment, the consumer data may include at least one of: demographic data, consumer-supplied preferences, advertising data, offer data, and consumer behavior data.

In step 708, a specific content profile 222 may be identified, in the content database 220, based on at least the included at least one associated news category and the identified plurality of news interest levels. In step 710, the at least one piece of content included in the identified specific content profile 222 may be transmitted, by a transmitting device (e.g., the transmitting unit 202), to the consumer 102.

In one embodiment, the consumer profile 214 may further include consumer feedback data associated with the consumer 102, and the identified plurality of news interest levels may be further based on the consumer feedback data included in the consumer profile 214 and associated with the consumer 102. In a further embodiment, the method 700 may further include: receiving, by a receiving device (e.g., the receiving unit 202), a feedback notification including an indication of a consumer response to the transmitted at least one piece of content; and updating, in the consumer profile 214, the consumer feedback data based on the indication of the consumer response.

### Computer System Architecture

FIG. 8 illustrates a computer system 800 in which embodiments of the present disclosure, or portions thereof, may be implemented as computer-readable code. For example, the processing server 108 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 4, 6 and 7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. The processor device 804 may be connected to a communications infrastructure 806, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive or universal serial bus port, the removable storage unit 818 may be a floppy disk or portable flash drive, respectively. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

The computer system 800 may further include a display interface 802. The display interface 802 may be configured to allow data to be transferred between the computer system 800 and external display 830. Exemplary display interfaces 802 may include high-definition multimedia interface (HDMI), digital visual interface (DVI), video graphics array (VGA), etc. The display 830 may be any suitable type of display for displaying data transmitted via the display interface 802 of the computer system 800, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 808 and secondary memory 810, which may be memory semiconductors (e.g., DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 3, 4, 6 and 7, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

Techniques consistent with the present disclosure provide, among other features, systems and methods for identifying news interest levels and distributing news-related content. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

1. A method for identifying news interest levels, comprising:
storing, in a transaction database, a plurality of transaction data entries, wherein each transaction data entry includes data related to a payment transaction involving a consumer of a plurality of consumers including at least transaction data and a consumer identifier associated with the involved consumer;
storing, in a rules database, a plurality of interest scoring rules, wherein each interest scoring rule is associated with at least one news category;
identifying, in the transaction database, a subset of transaction data entries where each transaction data entry in the subset includes a common consumer identifier associated with a specific consumer of the plurality of consumers;
identifying, by a processing device, a plurality of news interest levels based on at least an application of the plurality of interest scoring rules to the transaction data included in the transaction data entries of the subset of transaction data entries; and
transmitting, by a transmitting device, the identified plurality of news interest levels for use in identifying news-related content for distribution to a consumer associated with the common consumer identifier.

2. The method of claim 1, further comprising:
receiving, by a receiving device, a request for news interest levels, wherein the request includes the common consumer identifier.

3. (canceled)

4. The method of claim 1, wherein application of the plurality of interest scoring rules to the transaction data included in the transaction data entries of the subset of transaction data entries includes:
identifying, by the processing device, transaction behavior for the specific consumer based on at least the transaction data included in the transaction data entries of the subset of transaction data entries; and
identifying, by the processing device, an associated purchase model of a plurality of consumer purchase models based on the identified transaction behavior for the specific consumer and the plurality of interest scoring rules, wherein
the identified plurality of news interest levels are based on the identified associated purchase model.

5. (canceled)

6. (canceled)

7. The method of claim 1, wherein the transaction data includes product data associated with at least one product purchased in the corresponding payment transaction.

8. The method of claim 1, wherein the consumer identifier is a payment account identifier corresponding to a payment account associated with the associated consumer.

9. The method of claim 1, wherein the identified plurality of news interest levels are further based on at least one of: browsing data, consumer preferences, demographic data, advertising data, consumer response data, and consumer feedback provided by the specific consumer associated with the common consumer identifier.

10. (canceled)

11. A method for distributing news-related content, comprising:
storing, in a consumer database, a consumer profile, wherein the consumer profile includes data related to a consumer including at least a plurality of transaction data entries, each transaction data entry being related to a payment transaction involving the consumer and including at least transaction data;
storing, in a content database, a plurality of content profiles, wherein each content profile includes data related to a news-related content item including at least one piece of content and at least one associated news category;
identifying, by a processing device, a plurality of news interest levels for the consumer based on at least one interest scoring rule and the transaction data included in the plurality of transaction data entries of the consumer profile, wherein each news interest level is associated with at least one news category;
identifying, in the content database, a specific content profile based on at least the included at least one associated news category and the identified plurality of news interest levels; and
transmitting, by a transmitting device, the at least one piece of content included in the identified specific content profile to the consumer.

12. (canceled)

13. (canceled)

14. The method of claim 11, wherein the transaction data includes product data associated with at least one product purchased in the corresponding payment transaction.

15. (canceled)

16. (canceled)

17. The method of claim 11, wherein
the consumer profile further includes browsing data associated with the consumer, and
the identified plurality of news interest levels are further based on the browsing data included in the consumer profile and associated with the consumer.

18. The method of claim 11, wherein
the consumer profile further includes consumer data associated with the consumer, and
the identified plurality of news interest levels are further based on the consumer data included in the consumer profile and associated with the consumer.

19. (canceled)

20. The method of claim 11, wherein
the consumer profile further includes consumer feedback data associated with the consumer, and
the identified plurality of news interest levels are further based on the consumer feedback data included in the consumer profile and associated with the consumer.

21. (canceled)

22. The method of claim 11, wherein the identified plurality of news interest levels is further based on a purchase model associated with the consumer identified via application of the at least one interest scoring rule to the transaction data included in the plurality of transaction data entries of the consumer profile.

23. A system for identifying news interest levels, comprising:
a transaction database configured to store a plurality of transaction data entries, wherein each transaction data entry includes data related to a payment transaction involving a consumer of a plurality of consumers including at least transaction data and a consumer identifier associated with the involved consumer;
a rules database configured to store a plurality of interest scoring rules, wherein each interest scoring rule is associated with at least one news category;
a processing device configured to
identify, in the transaction database, a subset of transaction data entries where each transaction data entry in the subset includes a common consumer identifier associated with a specific consumer of the plurality of consumers, and
identify a plurality of news interest levels based on at least an application of the plurality of interest scoring rules to the transaction data included in the transaction data entries of the subset of transaction data entries; and
a transmitting device configured to transmit the identified plurality of news interest levels for use in identifying news-related content for distribution to a consumer associated with the common consumer identifier.

24. The system of claim 23, further comprising:
a receiving device configured to receive a request for news interest levels, wherein the request includes the common consumer identifier.

25. (canceled)

26. The system of claim 23, wherein application of the plurality of interest scoring rules to the transaction data included in the transaction data entries of the subset of transaction data entries includes:
identifying, by the processing device, transaction behavior for the specific consumer based on at least the transaction data included in the transaction data entries of the subset of transaction data entries; and
identifying, an associated purchase model of a plurality of consumer purchase models based on the identified transaction behavior for the specific consumer and the plurality of interest scoring rules, wherein
the identified plurality of news interest levels are based on the identified associated purchase model.

27. (canceled)

28. (canceled)

29. The system of claim 23, wherein the transaction data includes product data associated with at least one product purchased in the corresponding payment transaction.

30. (canceled)

31. The system of claim 23, wherein the identified plurality of news interest levels are further based on at least one of: browsing data, consumer preferences, demographic data, advertising data, consumer response data, and consumer feedback provided by the specific consumer associated with the common consumer identifier.

32. (canceled)

33. A system for distributing news-related content, comprising:
a consumer database configured to store a consumer profile, wherein the consumer profile includes data related to a consumer including at least a plurality of transaction data entries, each transaction data entry being related to a payment transaction involving the consumer and including at least transaction data;
a content database configured to store a plurality of content profiles, wherein each content profile includes data related to a news-related content item including at least one piece of content and at least one associated news category;
a processing device configured to
identify a plurality of news interest levels for the consumer based on at least one interest scoring rule and the transaction data included in the plurality of transaction data entries of the consumer profile, wherein each news interest level is associated with at least one news category, and
identify, in the content database, a specific content profile based on at least the included at least one associated news category and the identified plurality of news interest levels; and
a transmitting device configured to transmit the at least one piece of content included in the identified specific content profile to the consumer.

34. (canceled)

35. (canceled)

36. The system of claim 33, wherein the transaction data includes product data associated with at least one product purchased in the corresponding payment transaction.

37. (canceled)

38. (canceled)

39. The system of claim 33, wherein
the consumer profile further includes browsing data associated with the consumer, and
the identified plurality of news interest levels are further based on the browsing data included in the consumer profile and associated with the consumer.

40. The system of claim 33, wherein
the consumer profile further includes consumer data associated with the consumer, and
the identified plurality of news interest levels are further based on the consumer data included in the consumer profile and associated with the consumer.

41. (canceled)

42. The system of claim 33, wherein
the consumer profile further includes consumer feedback data associated with the consumer, and
the identified plurality of news interest levels are further based on the consumer feedback data included in the consumer profile and associated with the consumer.

43. The system of claim 33, further comprising:
a receiving device configured to receive a feedback notification including an indication of a consumer response to the transmitted at least one piece of content, wherein
the processing device is further configured to update, in the consumer profile, the consumer feedback data based on the indication of the consumer response.

44. The system of claim 33, wherein the identified plurality of news interest levels is further based on a purchase model associated with the consumer identified via application of the at least one interest scoring rule to the transaction data included in the plurality of transaction data entries of the consumer profile.
